(19) United States
(12) Patent Application Publication
(10) Pub. No.: US 2019/0142218 A1
(43) Pub. Date: May 16, 2019

(54) SYSTEM AND METHOD FOR COOKING FOOD WITH RADIANT HEAT

(71) Applicants: Ronald M. POPEIL, Beverly Hills, CA (US); Alan L. BACKUS, Los Angeles, CA (US); Valentina POPEIL, Beverly Hills, CA (US); Contessa POPEIL, Beverly Hills, CA (US)

(72) Inventors: Ronald M. POPEIL, Beverly Hills, CA (US); Alan L. BACKUS, Los Angeles, CA (US); Valentina POPEIL, Beverly Hills, CA (US); Contessa POPEIL, Beverly Hills, CA (US)

(21) Appl. No.: 16/189,650

(22) Filed: Nov. 13, 2018

Related U.S. Application Data
(63) Continuation-in-part of application No. 15/862,175, filed on Jan. 4, 2018.
(60) Provisional application No. 62/584,374, filed on Nov. 10, 2017.
(60) Provisional application No. 62/584,374, filed on Nov. 10, 2017.
(60) Provisional application No. 62/715,897, filed on Aug. 8, 2018.

(51) Int. Cl. A47J 37/06; A23L 5/10; A23L 13/50; F24C 7/04

(52) U.S. Cl. CPC A47J 37/0664; A47J 37/0641; A47J 37/0694; A23V 2002/00; A23L 13/57; F24C 7/04; A23L 5/15

(57) ABSTRACT

A system and method for cooking food items with radiant energy includes a radiant heat fryer having a cooking support rack that can selectively dispose a food item at an angle. The radiant heat fryer includes a radiant heat element that can be disposed over the food item to cook the food item. The cooking support rack is configured in a substantially horizontal configuration for a first cooking cycle to partially cook the food item. The cooking support rack is reconfigured to dispose the food item at an angle and the food item is then cooked for a second cooking cycle.

### CROSS-REFERENCE TO RELATED APPLICATIONS

This application is a continuation-in-part of application Ser. No. 15/862,175 filed on Jan. 4, 2018, which claims the benefit of U.S. Provisional Application No. 62/584,374 filed Nov. 10, 2017 which is incorporated herein by reference. This application also claims the benefit of U.S. Provisional Application No. 62/584,374 filed Nov. 10, 2017 and also claims the benefit of U.S. Provisional Application No. 62/715,897 filed Aug. 8, 2018, both of which are incorporated herein by reference.

### TECHNICAL FIELD

This application relates generally to cooking foods using radiant heat and hot air movement. The application relates more particularly to methods and apparatuses for selectively positioning food items relative to radiant heat sources.

### SUMMARY

In a first example embodiment, a radiant heat fryer includes a radiant heat element that is disposed over a food item and a cooking support rack that can selectively dispose the food item at an angle relative to the radiant heat element during cooking.

In a second example embodiment, a system includes a wire shelf that supports a food item at a selectable angle during cooking and a radiant heat element that is disposed vertically over the food item to cook the food item on the wire shelf.

In a third example embodiment, a method includes configuring a cooking support rack of a radiant heat fryer at a first configuration that is either horizontal or angled, positioning the food item on the cooking support rack, and partially cooking the food item by applying radiant heat for a first period of time. The cooking support rack is then reconfigured to a second configuration different from the first configuration which is angled if the first configuration was horizontal, or horizontal if the first configuration was angled. The food item is cooked for a second period of time by applying radiant heat.

### BACKGROUND

Convection ovens which utilize both air movement and radiant heat sources are in common household use today. At least three broad categories of these devices can be found in the marketplace.

The first category includes devices such as the Nuwave Oven, which are generally cylindrical in design, with a drip pan base, one or more wire shelves, and a clear cake cover type dome with a utility box on the box's top surface. This utility box typically contains a motor driven fan, a rod type radiant heating element proximate to the fan, and a control circuit which controls cooking time and temperature.

Home air fryers are another category of commonly found convection ovens that utilize both air movement and radiant heat. These devices come in various shapes and sizes but share in common: a motor driven fan, a rod type radiant heat element, and a cooking control circuit. Home air fryers typically have a drawer-type wire basket which slides forward from the device's lower frontal face.

A third commonly available category of convection ovens which utilize both air movement and radiant heat sources is kitchen countertop convection ovens such as made by KitchenAid, Brevel, Cuisinart and others. These typically resemble microwave ovens with a large hinged front door, rod type heating elements arranged on the top and the bottom of the cooking cavity, with a motor driven fan mounted in their sidewalls.

### BRIEF DESCRIPTION OF THE DRAWINGS

Various embodiments will become better understood with regard to the following description, appended claims, and accompanying drawings wherein:

FIG. 1 is a perspective view of an example embodiment of a wire shelf in an assembled use configuration;

FIG. 2 is a perspective view of an example embodiment of the wire shelf of FIG. 1 in a compacted storage configuration;

FIG. 3 is a perspective view of an example embodiment of the wire shelf of FIG. 1 in an inclined use configuration;

FIG. 4 is a perspective view of an example embodiment of wire shelves of FIG. 1 in stacked configuration;

FIG. 5 is a frontal view of the wire shelf of FIG. 1;

FIG. 6 is a frontal view of the wire shelf of FIG. 2;

FIG. 7 is a frontal view of the wire shelf of FIG. 3;

FIG. 8 is a frontal view of the wire shelves of FIG. 4;

FIG. 9 is a perspective view of an example embodiment of the wire shelf of FIG. 1 with one support leg removed and the other support leg illustrated in both the use and the storage configurations;

FIG. 10 is a perspective view of an embodiment of a radiant cooking apparatus;

FIG. 11 is a wireframe perspective view of an embodiment of a radiant cooking apparatus;

FIG. 12 is an exploded perspective view of an embodiment of a radiant cooking apparatus;

FIG. 13 is a perspective view of an embodiment of a radiant cooking apparatus in a compacted storage configuration;

FIG. 14 is a perspective view of an embodiment of a radiant cooking apparatus in a use configuration without an extension ring;

FIG. 15 is a perspective view of a second embodiment of a radiant cooking apparatus;

FIG. 16 is a perspective view of an embodiment of a cooking rack and drip pan of the radiant cooking apparatus of FIG. 15;

FIG. 17 is a perspective view of an embodiment of the cooking rack of FIG. 16 in an inclined configuration;

FIG. 18 is a top view of the cooking rack and drip pan of FIG. 16;

FIG. 19A is a partial side view of an embodiment of the radiant cooking apparatus of FIG. 15;

FIG. 19B is a partial side view of an embodiment of the radiant cooking apparatus of FIG. 15 with the cooking rack in the inclined configuration; and

FIG. 20 is a flowchart of example cooking operations for radiant cooking apparatuses.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

Larger food items, such as poultry, are typically cooked for long periods in conventional ovens. More recently, it became popular to cook fowl by immersing it in hot oil. Cooking in hot oil provides quicker cooking and provides a unique flavor. However, oil fryers, particularly those that employ flame heating, can be dangerous. Oil, which is flammable, can overflow, contact the flame and ignite.

More recently, electric oil heaters provided for increased safety for hot oil poultry frying. However, other drawbacks, such as large quantities of oil needed, and difficulty in setup or cleanup, still exist.

The present disclosure is directed toward improvements of convection ovens which utilize radiant heat. The disclosure is directed, at least in part, toward cooking more evenly and efficiently various foods including irregularly shaped foods, such as turkeys, ducks, legs of lamb, geese, etc., while maintaining food color and appearance commensurate with that of conventional cooking methods.

Radiant heat frying, such as by hot air, infrared, or a combination thereof, negates any need for oil. A single heating element placed below the poultry requires flipping the poultry at some point to complete cooking. Placement of a heating element below the bird is a natural positioning given that heat from the heating element rises into the food. However, grease and other drippings during cooking will soil the heating element, likely baking the residue onto the element, rendering a difficult cleanup and boiling away or burning away liquids that could have been used for gravy, soup or basting.

Placement of a radiant heating element above the bird can alleviate cleanup problems. However, a fan or other blower may be required to direct the heat downward, toward the bird. When a bird, such as a turkey, is oriented breast up for cooking, there is a distinct angle from horizontal for much of the bird, rendering some of it closer to the heat source and some of it further away which can cause uneven cooking.

As illustrated in the attached drawings, a pivot-able or otherwise position-able support, operable like a kickstand or a support member, on a cooking support rack can be used to reposition the bird so as to be better aligned with the heating element. A removable rack support or food item support, as illustrated, holds the bird on the rack when it is tilted.

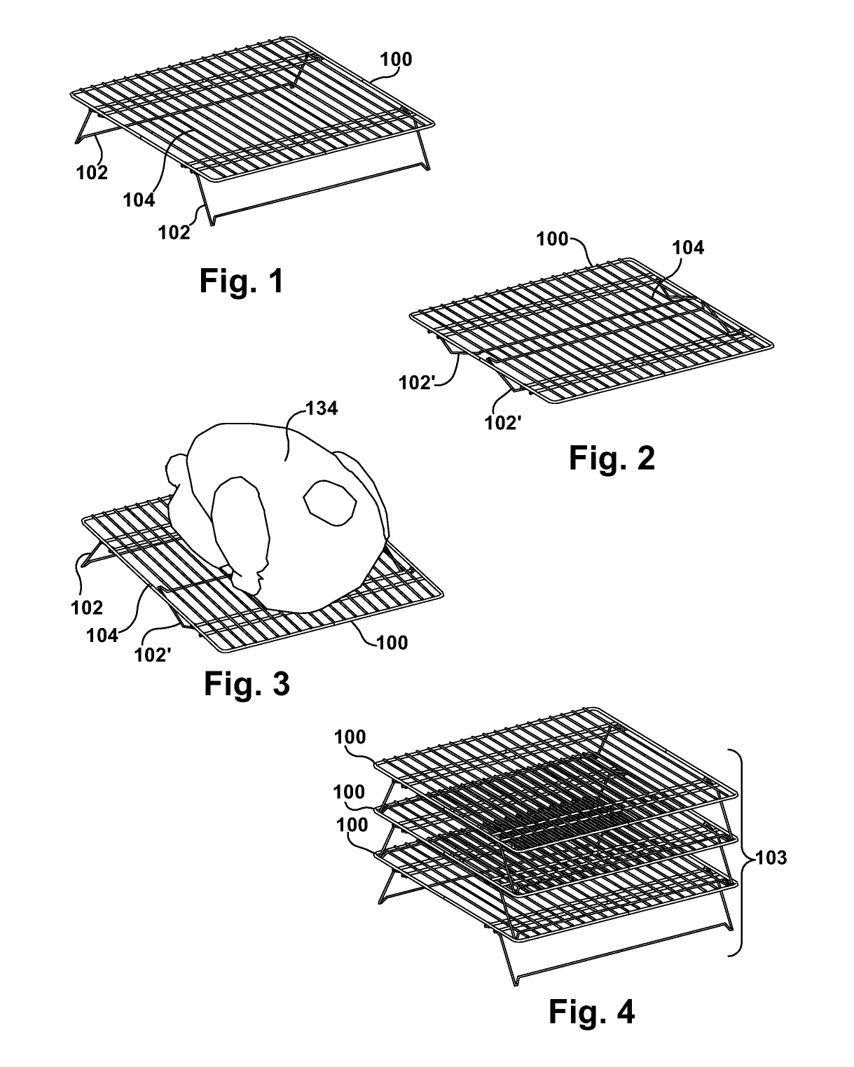

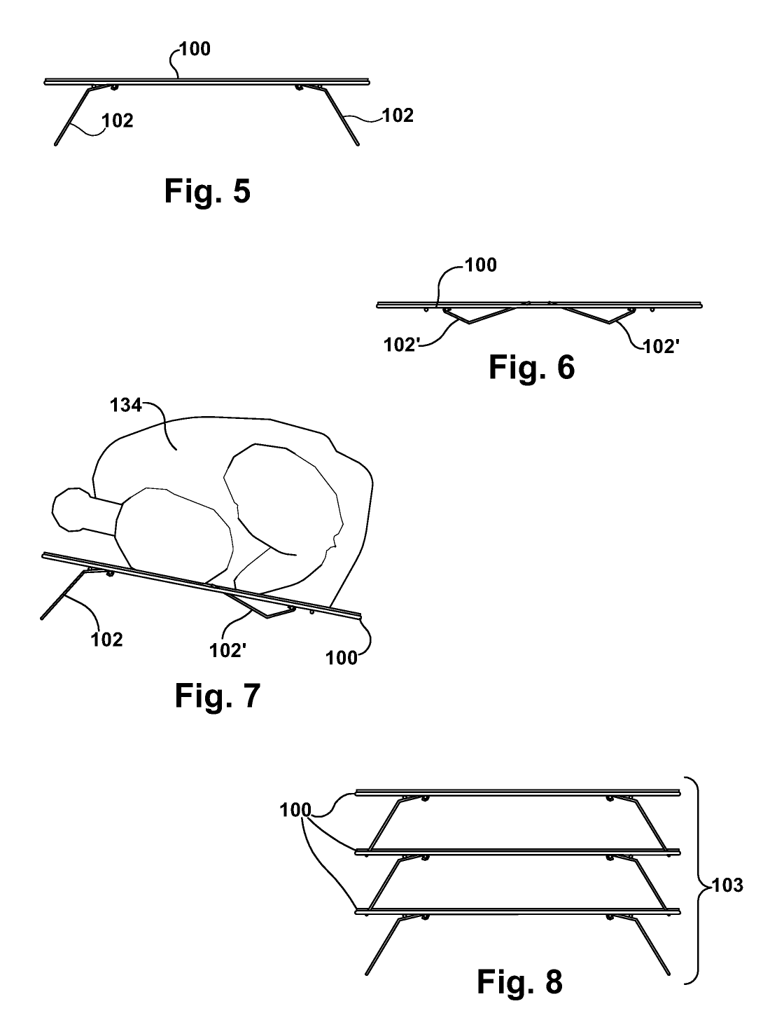

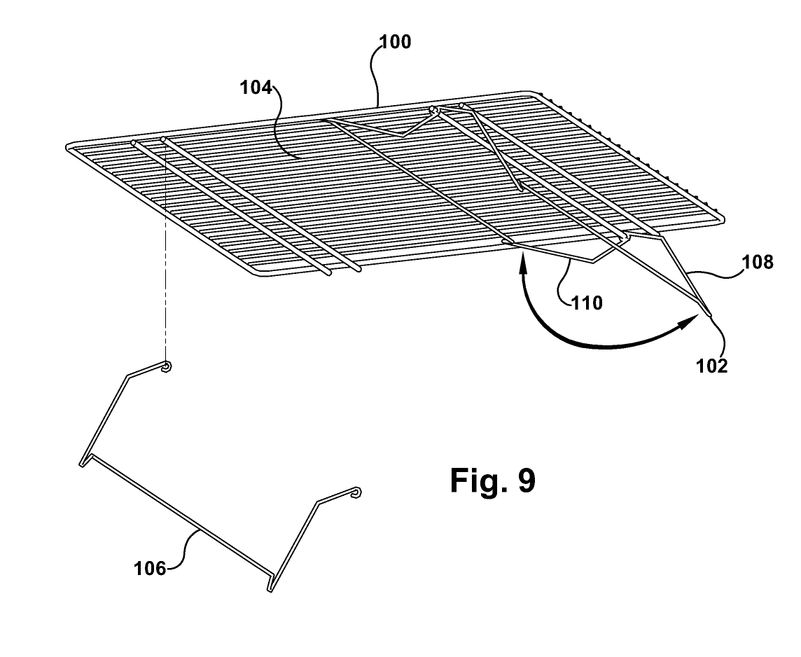

Referring first to FIGS. 1-9, example embodiments of wire shelves 100 are presented. FIGS. 1-4 are perspective views of wire shelves 100. FIGS. 5-8 are side views of the wire shelves 100 of FIGS. 1-4. FIGS. 1 and 5 illustrate a wire shelf 100 that includes support legs 102 rotatably connected to a wire platform 104. The support legs 102 are illustrated in an assembled use configuration or fully open configuration. FIGS. 2 and 6 illustrate a wire shelf 100 with the support legs 102′ in a compacted storage configuration or collapsed configuration. FIGS. 3 and 7 illustrate a wire shelf 100 in an inclined use configuration with one of the support legs 102 in the fully open configuration and one of the support legs 102′ in the collapsed configuration. A food item 134 that is positioned on the wire shelf 100 in the inclined use configuration will have an improved orientation relative to a radiant heat source for improved cooking of the food item as will be explained in greater detail below. FIGS. 4 and 8 illustrate a plurality of wire shelves 100 in a stacked configuration 103. FIG. 9 illustrates a wire shelf 100 with a detached support leg 106, and an attached support leg 102 that is rotatable between a use (or open) condition 108 and a storage (or collapsed) condition 110. The support legs 102, 106 can connect to cross-bar members of the wire platform 104 as illustrated.

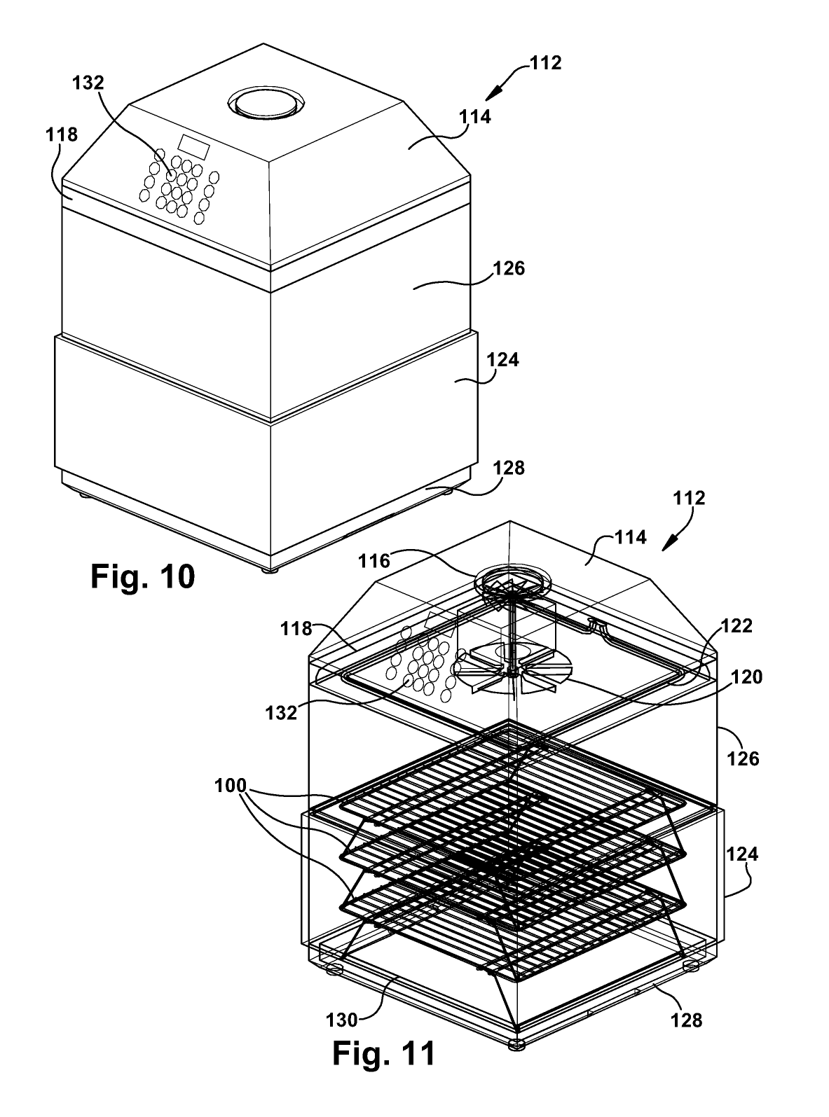

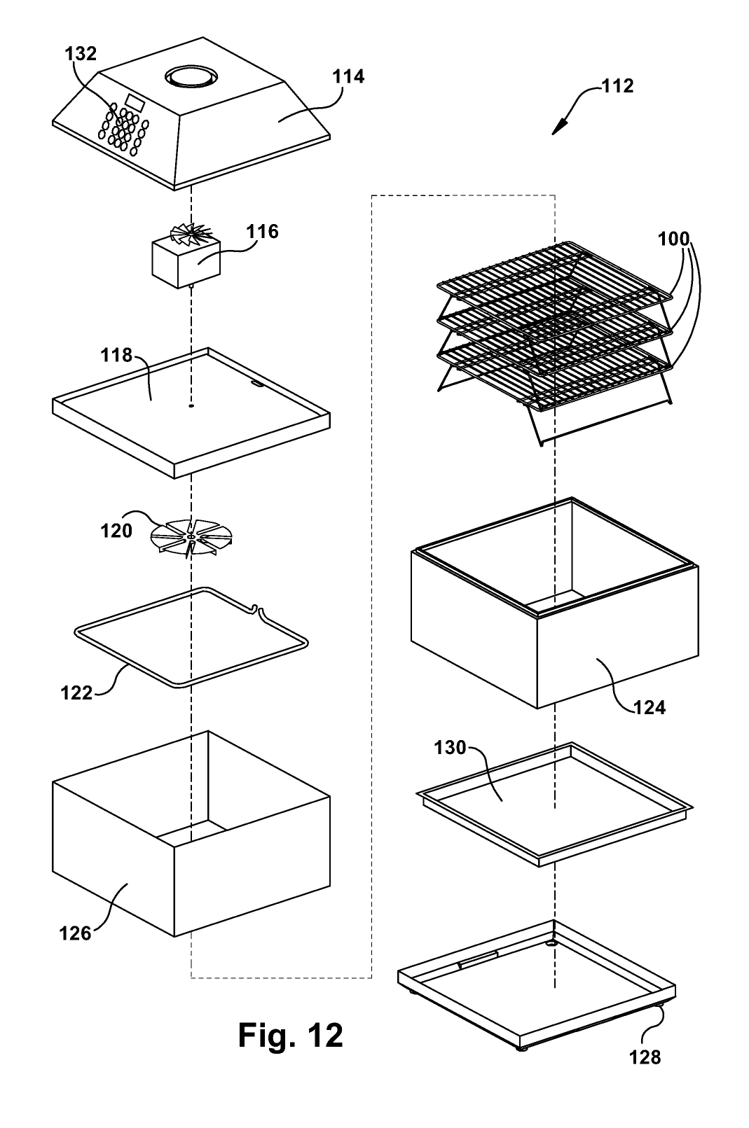

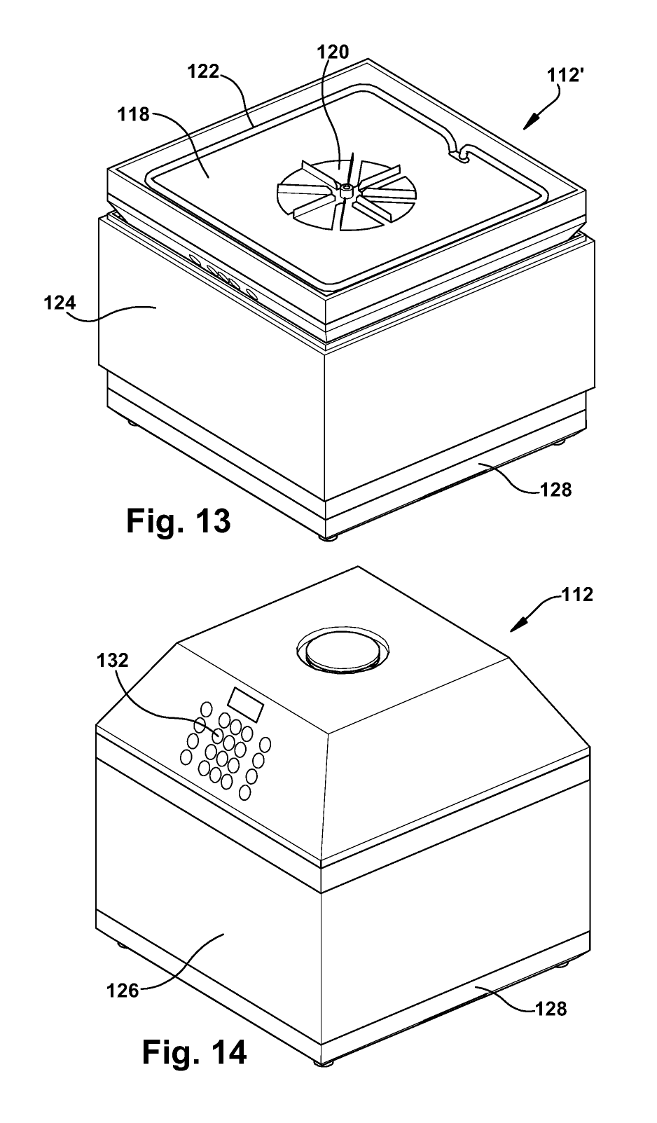

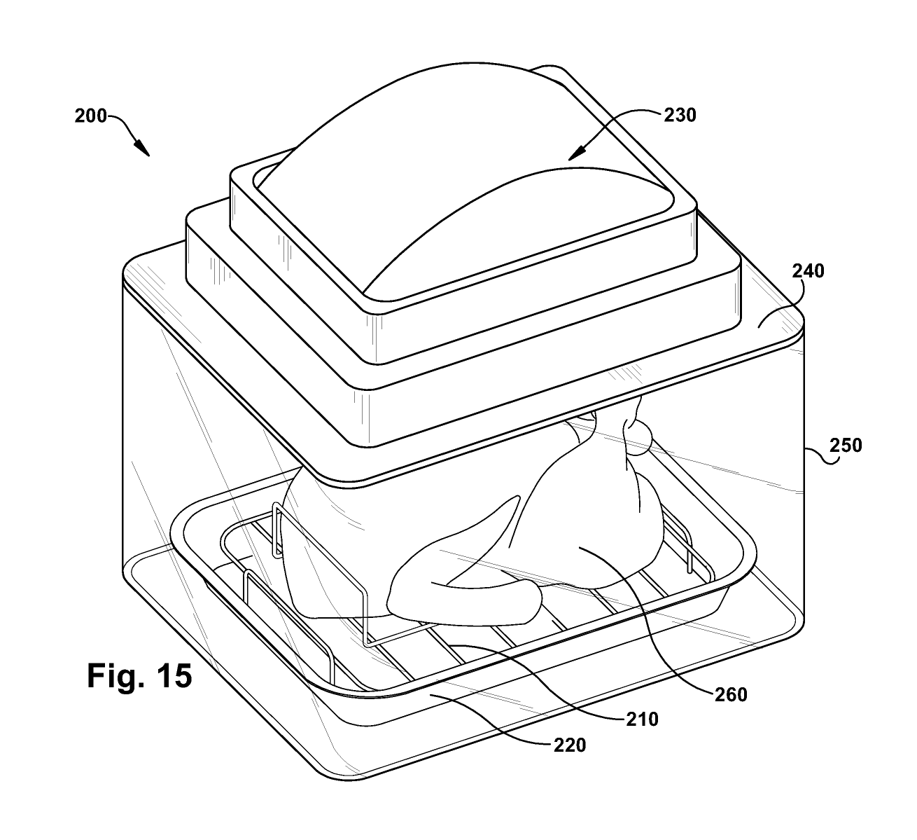

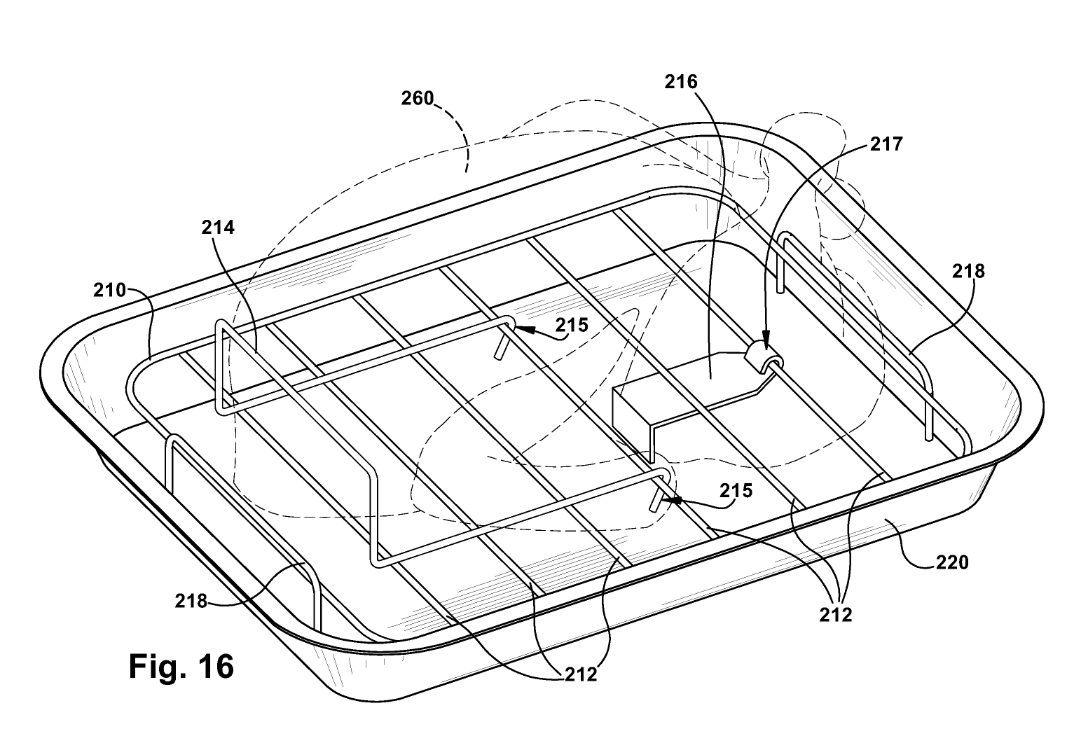

Referring to FIGS. 10-14, a first example embodiment of a radiant cooking apparatus 112 is presented. The radiant cooking apparatus 112 includes a control utility box 114 that further includes an electric motor 116, shiny heat reflector 118, motor driven oven circulation fan blade 120, and radiant rod type heating element 122. Control utility box 114 removably drop mounts onto upper translucent sidewalls 126. Upper translucent sidewalls 126 removably drop mounts onto extension ring 124, as shown in FIGS. 10 and 11, or removably drop mounts onto base 128, as shown in FIG. 14. If upper translucent sidewalls 126 removably drop mounts onto extension ring 124, extension ring 124 removably drop mounts onto base 128. Drip pan 130 removably mounts within base 128. One or more wire shelves 100, at user discretion, can mount within upper translucent sidewalls 126 and/or within extension ring 134 (as illustrated in the wireframe perspective view of FIG. 11). Extension ring 134 may be translucent similar to upper translucent sidewall 126. In embodiments, the sidewalls 126 and extension rings 134 can be transparent or opaque as would be understood in the art. FIG. 12 illustrates an exploded view of the radiant cooking apparatus 112. FIG. 13 illustrates how the radiant cooking apparatus 112′ may be compacted for storage by placing the extension ring 124 over the upper translucent sidewalls 126 and then placing the control utility box 114 inverted into the upper translucent sidewalls 126.

In operation, as a nonlimiting and nonexhaustive example, a user places drip pan 130 within base 128, and then places one or more wire shelves 100 into drip pan 130 (as illustrated in the wireframe perspective view of FIG. 11). The user then places a food item to be cooked onto the shelves 100. The user then mounts either the extension ring 124 or the upper translucent sidewalls 126 onto the base 128, by lowering either onto the base 128. If the extension ring 124 was placed onto the base 128, the user then lowers the upper translucent sidewalls 126 onto the extension ring 124. The user then places the control utility box 114 on top of either the extension ring 124 or the upper translucent sidewalls 126. The user then inputs into the control display panel 132 the desired cooking parameters. After cooking is complete, the user then removes and serves the food.

In the event the user is cooking an irregular shaped food item, such as, as nonlimiting and nonexhaustive examples, a turkey, a chicken, a leg of lamb, etc., the user may fold back one of the support legs 102 as shown in FIGS. 3 and 7 so as to incline the wire platform 104, so that the food item 134 may cook more evenly. The inclined wire shelf 100 along with the food item 134 is then placed into the drip pan 130.

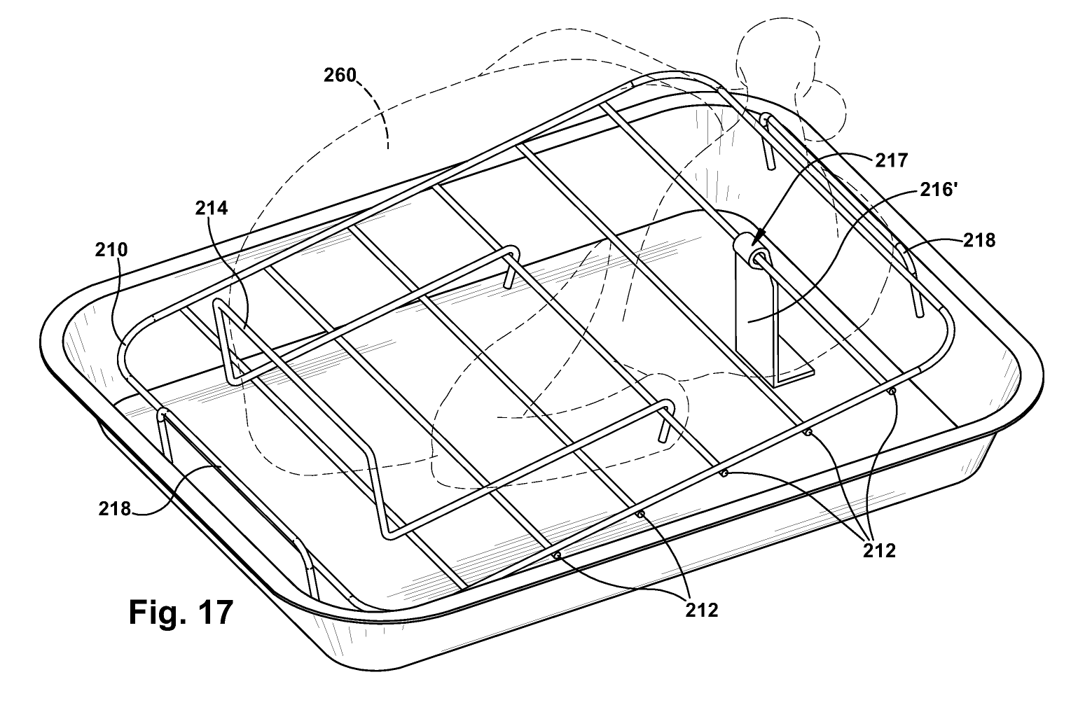

Referring now to FIG. 15, a perspective view of a second embodiment of a radiant cooking apparatus 200 is presented. The radiant cooking apparatus 200 includes a cooking support rack 210, a drip pan 220, control and heating elements 230, a removable top 240, and translucent side walls 250. A food item 260 to be cooked is placed on the cooking support rack 210 in the radiant cooking apparatus 200.

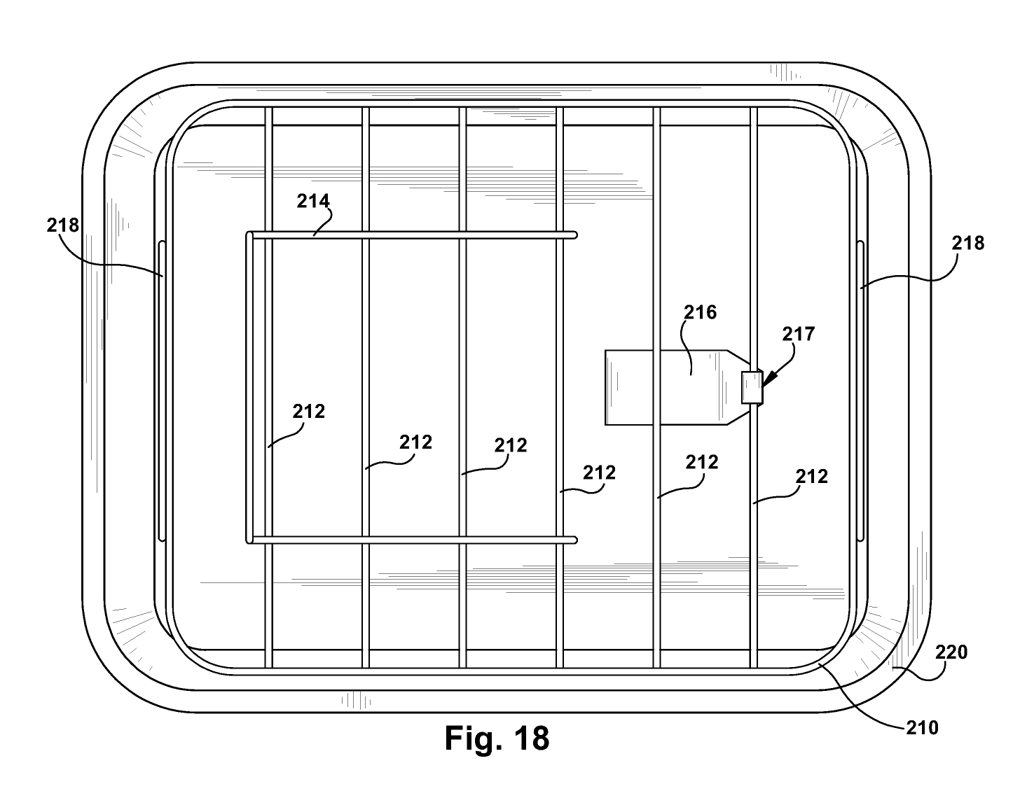

Referring now also to FIG. 16 a perspective view of the cooking support rack 210 and drip pan 220 of the radiant cooking apparatus of FIG. 15 are presented. The cooking support rack 210 includes a wire shelf 212, a removable food item support 214 or rack support, a rotatable kickstand 216, and fixed support legs 218. The removable food item support 214 includes wire bends 215 for securing to the wire shelf 212. The wire bends 215 allow the removable food item support 214 to be positioned along the wire shelf 212 at a position that is appropriate based on the side and shape of the food item 260. The wire bends 215 also allow the removable food item support 214 to be easily removed for cleaning. The rotatable kickstand 216 includes a loop 217 that secures to the wire shelf 212. In various configurations the loop 217 can be permanently secured to the wire shelf 212 or removable for ease of cleaning. FIG. 17 illustrates the rotatable kickstand 216′ in a rotated configuration which lifts one side of the removable food item support 214 to incline the cooking support rack 210. FIG. 18 is a top view of the cooking rack and drip pan of FIG. 16.

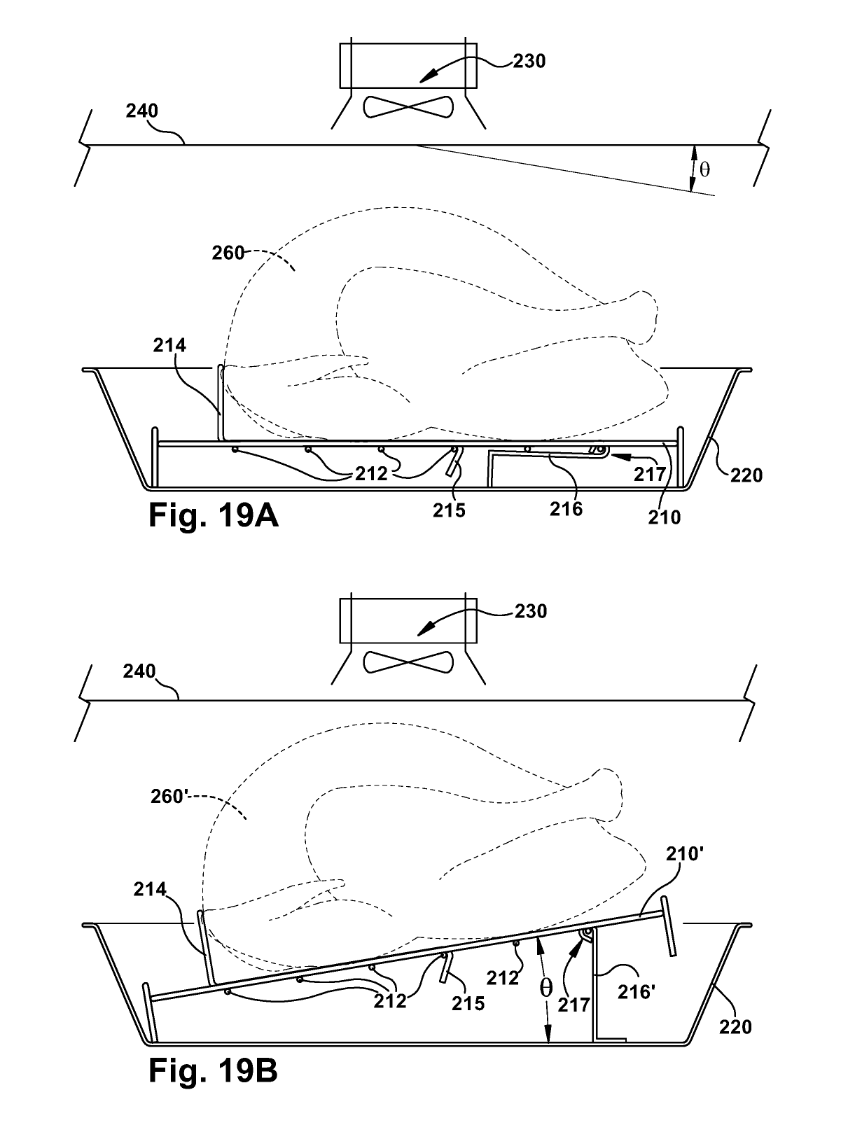

FIGS. 19A and 19B are partial side views of the radiant cooking apparatus of FIG. 15. FIG. 19A illustrates the cooking support rack 210 in a substantially horizontal configuration. As illustrated in FIG. 19A, when the cooking support rack 210 is in the horizontal configuration the food item 260, illustrated as a turkey, includes a substantial portion that is at an angle θ relative to the removable top 240, and more importantly the control and heating elements 230. As illustrated in FIG. 19B, by rotating the kickstand 216′ into the rotated configuration, the cooking support rack 210′ is placed in an inclined configuration at an angle θ. Placing the cooking support rack 210′ at the inclined angle θ decreases the angle of at least part of the food item 260′, such as the breast of the turkey relative to the heating elements 230. Repositioning the food item 260′ serves to increase the proximity of portions of the food item 260′ to the heating elements 230 allowing the radiant cooking apparatus to more evenly cook the food item 260′. In operation, the food item 260 can be cooked for part of the cooking time with the cooking support rack 210 in the horizontal configuration, and part of cooking time with the cooking support rack 210′ in the inclined configuration as illustrated in FIG. 19B. For example, a turkey can be cooked breast side down for a period of time with the cooking support rack 210 in the horizontal configuration as illustrated in FIG. 19A, and breast side up for a period of time with the cooking support rack 210′ in the inclined configuration.

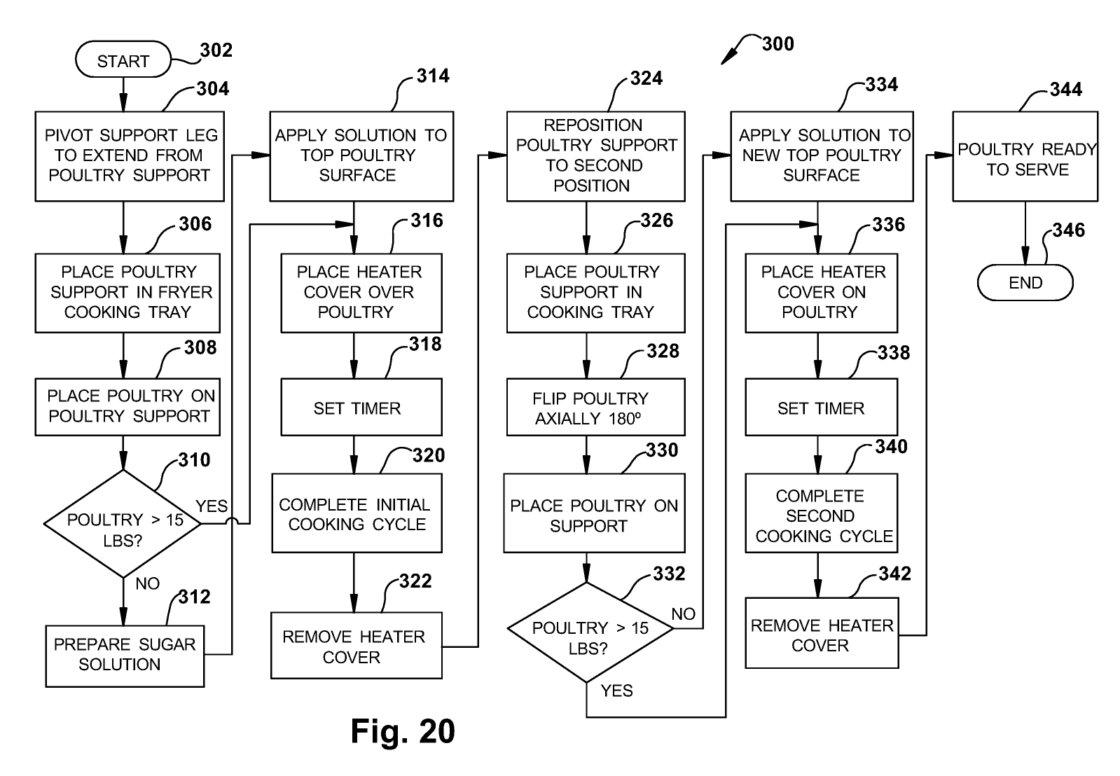

Referring now to FIG. 20, example cooking operations 300 for radiant heat cooking apparatuses are presented. Depending on the particular heating system, calculated poultry cooking times can be approximately 4 minutes per pound rounded up or down per side, e.g. 17.2 would be 17 lbs.×4 and 17.5 would be 18 lbs. When one cooks a large, 16 to 18 pound turkey using radiant heat, because the size of the bird and the relatively long cooking time required, the turkey comes out browned and beautiful, and attractive like an actual fried turkey automatically. However, with smaller sized turkeys such as those weighing 9 to 14 lbs., there is less total cooking time and therefore, the skin may not brown to a beautiful, dark brown as may be desired.

In accordance with the forgoing, the subject application includes a process that allows for the skin to brown beautifully, even on small birds that includes covering the skin with a sugar based syrup (e.g. pancake syrup, corn syrup, honey, simple syrup), or even dry sugar. For birds 9 to 12 lbs., after applying the coloring syrup, one dries the turkey and then cooks it as instructed. The skin turns brown despite the cooking time being much less than the cooking time of a larger bird and looks beautiful. For birds 12 to 14 lbs., after applying the coloring syrup, one rinses the bird, then dries it completely and then cooks as instructed. Skin turns brown despite the cooking time being much less than the cooking time of a larger bird and looks beautiful.

Example cooking operations 300 for a radiant cooking apparatus start at block 302 and proceed to block 304 where a support leg is pivoted to extend from the poultry support to place the poultry support in the horizontal configuration. In an embodiment, the support legs of the wire shelf of radiant cooking apparatus of FIGS. 1 and 5 can be configured in the fully open configuration to place the wire shelf in a horizontal configuration. In another embodiment, the kickstand of the cooking support rack of the radiant cooking apparatus of FIGS. 16 and 19A can be rotated so as to place the cooking support rack in the horizontal configuration.

The poultry support is then placed into the radiant cooking apparatus at block 306, and the poultry is placed on the poultry support of the radiant cooking apparatus at block 308. If the poultry is less than approximately 15 lbs operation proceeds to block 312 where a sugar solution or rub is prepared. At block 314 the sugar solution or rub is applied to the top of the poultry that will be nearest the heating elements of the radiant heat fryer. At block 316 the heater cover is placed over the poultry. If the turkey was greater than 15 lbs, operation proceeded from block 310 to block 316 directly.

At block 318 the timer is set, for example to cook the poultry for approximately half of the total cooking time, and at block 320 the turkey is cooked for the initial cooking cycle. At block 322 the heater cover is removed and at block 324 the poultry support is repositioned into an inclined configuration. In an embodiment, one of the support legs of the wire shelf of radiant cooking apparatus of FIGS. 3 and 7 can be configured in the collapsed configuration to place the wire shelf in an inclined configuration. In another embodiment, the kickstand of the cooking support rack of the radiant cooking apparatus of FIGS. 17 and 19B can be rotated to place the cooking support rack into the inclined configuration.

The poultry is then flipped axially at block 330. For example, if the poultry was cooked breast side down for the initial cooking cycle in block 320, then the poultry can be flipped breast side up at block 330. The poultry is then placed on the poultry support at block 330. If the poultry is less than approximately 15 lbs., operation proceeds to block 334 where the sugar solution or rub is applied to the top of the poultry that will be nearest the heating elements of the radiant heat fryer. At block 336 the heater cover is placed over the poultry. If the turkey was greater than 15 lbs., operation proceeded from block 332 to block 336 directly.

At block 338 the timer is set to cook the poultry for the remainder of the total cooking time, and at block 340 the turkey is cooked for the second cooking cycle. At block 342 the heater cover is removed and at block 344 the poultry is ready to be served and cooking operations terminate at block 346.

Although the cooking operation 300 described above initially position the poultry support in the horizontal configuration for the first cooking cycle and in the inclined configuration for the second cooking cycle, the operations could be performed in any suitable order as would be understood in the art. For example, the poultry could initially be positioned breast side up and cooked with the poultry support in the inclined configuration, and then flipped breast side down and cooked with the poultry support in the horizontal configuration. In various embodiments, any suitable food item can be cooked in the radiant heat fryer, and food items can be cooked in the inclined configuration for any portions of the cooking cycle, including the entire cooking cycle or portions of cooking cycles that include more than two discrete cooking cycles as would be understood in the art.

In light of the foregoing, it should be appreciated that the present disclosure significantly advances the art of cooking food items with radiant energy. While example embodiments of the disclosure have been disclosed in detail herein, it should be appreciated that the disclosure is not limited thereto or thereby inasmuch as variations on the disclosure herein will be readily appreciated by those of ordinary skill in the art. The scope of the application shall be appreciated from the claims that follow.

What is claimed is:

1. A radiant heat fryer, comprising:
a radiant heat element configured to be disposed vertically over a food item having a first generally flat exterior surface and a second opposed, generally curved exterior surface that is placed in the radiant heat fryer; and
a cooking support rack configured to selectively direct the generally flat exterior surface of the food item at a first angle toward the heating element during a first cooking stage in the radiant heat fryer, the cooking support rack further configured to selectively direct the generally curved exterior surface of the food item, reoriented on the support rack, at a second angle toward the heat element.

2. The radiant heat fryer of claim 1, wherein the cooking support rack further comprises:
a wire shelf configured to support the food item during cooking;
a first support leg in communication with the wire shelf; and
a second support leg in communication with the wire shelf and configured to transition between an open configuration and a collapsed configuration,
wherein when the second support leg is in the collapsed configuration, the wire shelf is configured to support the food item at the angle.

3. The radiant heat fryer of claim 2, wherein second support leg is rotatably connected to the wire shelf.

4. The radiant heat fryer of claim 2, wherein the cooking support rack further comprises:
a food item support in communication with the wire shelf and configured to prevent the food item from sliding on the wire shelf when disposed at the angle.

5. The radiant heat fryer of claim 1, wherein the cooking support rack further comprises:
a kickstand in communication with the cooking support rack and configured to transition between an open configuration and a collapsed configuration,
wherein when the kickstand is in the open configuration, the cooking support rack supports the food item at the angle.

6. The radiant heat fryer of claim 5, wherein the cooking support rack is a wire shelf and wherein the kickstand is rotatably connected to a support wire of the wire shelf.

7. The radiant heat fryer of claim 5, wherein the cooking support rack further comprises:
a food item support configured to prevent the food item from sliding when the cooking support rack is disposed at the angle.

8. The radiant heat fryer of claim 1, wherein the angle is selected to reduce the angle of at least a part of the food item relative to the radiant heat element.

9. The radiant heat fryer of claim 10, wherein the angle is selected so as to allow repositioning of the food item during cooking to increase proximity of the food item to the radiant heat element.

10. The radiant heat fryer of claim 1, further comprising:
a fan configured to direct air heated by the radiant heat element toward the food item,
wherein the food item is cooked in the radiant heat fryer by a combination of the radiant heat element and the directed air.

11. A system comprising:
a wire shelf configured to support a food item at a selectable angle during cooking; and
a radiant heat element configured to be disposed vertically over the food item for cooking the food item.

12. The system of claim 11, further comprising:
a first support leg rotatably connected to the wire shelf and configured to transition between an open configuration and a collapsed configuration; and
a second support leg rotatably connected to the wire shelf and configured to transition between an open configuration and a collapsed configuration,
wherein when the first support leg is in the open configuration and the second support leg is in the collapse configuration, the wire shelf supports the food item at the angle, and
wherein when both the first support leg and the second support leg are in the open configuration the wire shelf supports the food item at a substantially horizontal angle.

13. The system of claim 11, further comprising:
a kickstand rotatably connected to a support wire of the wire shelf and configured to transition between an open configuration and a collapsed configuration,
wherein when the kickstand is in the open configuration, the cooking support rack supports the food item at the angle, and
wherein when the kickstand is in the collapsed configuration the wire shelf supports the food item at a substantially horizontal angle.

14. The system of claim 11, further comprising:
a food item support configured to be connected to the wire shelf and further configured to prevent the food item from sliding when the wire shelf is disposed at the angle.

15. The system of claim 11, wherein the angle is selected to reduce the angle of at least a part of the food item relative to the radiant heat element.

16. The system of claim 11, wherein the angle is selected so as to allow repositioning of the food item during cooking to increase proximity of the food item to the radiant heat element.

17. A method comprising:
configuring a cooking support rack of a radiant heat fryer in a first configuration selected from the group consisting of a substantially horizontal cooking support rack and an angled cooking support rack;
positioning a food item on the cooking support rack of the radiant heat fryer;
applying, by the radiant heat fryer, radiant heat to the food item for a first period of time to at least partially cook the food item on the cooking support rack in the first configuration;
reconfiguring the cooking support rack to a second configuration different from the configuration and selected from the group consisting of a substantially horizontal cooking support rack and an angled cooking support rack; and
applying, by the radiant heat fryer, radiant heat to the food item for a second period of time to cook the food item on the cooking support rack in the second configuration.

18. The method of claim 17 further comprising:
rotating the food item after applying radiant heat for the first period of time and before applying radiant heat for the second period of time.

19. The method of claim 17 further comprising:
selectively applying a sugar solution to the food item prior to applying radiant heat to the food item.

20. The method of claim 19 wherein the sugar solution is selectively applied based at least in part on a weight of the food item.
